(19) United States
(12) Patent Application Publication
(10) Pub. No.: US 2026/0288147 A1
(43) Pub. Date: Sep. 24, 2026

(54) AUTOMATIC POOL CLEANING DEVICE AND ITS CONTROLLING METHOD

(71) Applicant: Shenzhen Aiper Intelligent Co., Ltd., Shenzhen (CN)

(72) Inventor: Jiyong Zhou, Shenzhen (CN)

(21) Appl. No.: 19/573,084

(22) Filed: Mar. 20, 2026

(30) Foreign Application Priority Data
Mar. 20, 2025 (CN) 202510329388.8

(51) Int. Cl. G05D 1/467; E04H 4/16; G01B 11/24; G05D 1/648; G05D 105/10; G05D 107/00; G05D 111/10

(52) U.S. Cl. CPC G05D 1/467; E04H 4/1654; G01B 11/24; G05D 1/648; G05D 2105/10; G05D 2107/29; G05D 2111/17

(57) ABSTRACT

Disclosed are an automatic pool cleaning device and its control method. The automatic pool cleaning device includes a laser radar, and the control method includes: controlling the automatic pool cleaning device to move along walls of a pool; during the movement of the automatic pool cleaning device, obtaining contour information on a wall located to a side of the automatic pool cleaning device with the laser radar and determining a yaw angle for a subsequent movement of the automatic pool cleaning device based on the contour information on the wall; and controlling the subsequent movement of the automatic pool cleaning device based on the yaw angle.

### CROSS-REFERENCE

The present disclosure claims a benefit of, and priority to Chinese Patent Application No. 202510329388.8 filed on March 20, 2025, the disclosure of which is hereby expressly incorporated by reference herein in its entirety.

### TECHNICAL FIELD

The present disclosure relates to an automatic pool cleaning device and a method for controlling the automatic pool cleaning device in a field of cleaning device.

### BACKGROUND

Robot technology develops rapidly with a development of computer technology. Underwater robots have been widely utilized in various fields to assist tasks in water, such as underwater cleaning, underwater exploration, and underwater sightseeing.

### SUMMARY

In a first aspect, disclosed is a control method for an automatic pool cleaning device comprising a laser radar, the control method comprising: controlling the automatic pool cleaning device to move along walls of a pool; during the movement of the automatic pool cleaning device, obtaining contour information on a wall located to a side of the automatic pool cleaning device with the laser radar and determining a yaw angle for a subsequent movement of the automatic pool cleaning device based on the contour information on the wall; and controlling the subsequent movement of the automatic pool cleaning device based on the yaw angle.

In the control method, for example, the contour information comprises two-dimensional contour information or three-dimensional contour information.

In the control method, for example, the controlling the subsequent movement of the automatic pool cleaning device based on the yaw angle comprises: determining whether a distance between the automatic pool cleaning device and the wall satisfies a preset condition; and updating the yaw angle for the subsequent movement of the automatic pool cleaning device in a case where the distance satisfies the preset condition.

In the control method, for example, the preset condition comprises the distance being less than a minimum preset threshold or the distance being greater than a maximum preset threshold.

In the control method, for example, the contour information on the wall comprises information on a contour of the wall itself or a contour of an object near and independent of the wall.

In the control method, for example, the contour information on the wall comprises information on a contour of a first part of the wall facing a side surface of the automatic pool cleaning device and information on a contour of a second part of the wall obliquely or sideways in front of the automatic pool cleaning device.

In the control method, for example, the yaw angle enables the automatic pool cleaning device to move parallel to a contour of the wall or parallel to a contour of the object.

In the control method, for example, the yaw angle for the subsequent movement comprises a plurality of yaw angle values for moving to a plurality of positions.

In the control method, for example, the laser radar is installed at a side part or head part of the automatic pool cleaning device.

In the control method, for example, a light beam emitted by the laser radar is parallel to or intersects with a horizontal plane.

In the control method, for example, the contour information on the wall comprises information on a contour of a part of the wall obliquely or sideways in front of the automatic pool cleaning device, and the yaw angle for the subsequent movement comprises a plurality of yaw angle values at a plurality of different positions.

In a second aspect, disclosed is a automatic pool cleaning device comprising: a laser radar, and a processor configured to performing the control method in the above first aspect by executing a program in a storage.

In a third aspect, disclosed is computer storage medium having a computer program stored, the computer program performing the control method in the above first aspect when being executed by a processor.

### BRIEF DESCRIPTION OF THE DRAWINGS

FIG. 1 illustrates a process of a control method for the automatic pool cleaning device.

FIG. 2 illustrates scanning by a laser radar of the automatic pool cleaning device.

FIG. 3 illustrates a position for installing the laser radar.

### DETAILED DESCRIPTION

To clarify the purpose, technical solutions and advantages of the present disclosure, descriptions will be made clearly and completely in connection with the drawings. Some (not all) aspects are described, based on which other aspects obtained by those skilled in the art without creative work belong to the scope of this disclosure.

A robot for cleaning a pool, such as an automatic pool cleaning device, may move along edges of the walls of the pool to detect a boundary of the pool when planing a movement route. While moving along the edges, dirt for example at a waterline of the wall may also be cleaned. The more accurate a path for the movement along the edges, the more accurate the detection of the boundary of the pool, and in turn the better a coverage of the automatic pool cleaning device. For example, the automatic pool cleaning device may move along the edges by utilizing a single-point distance sensor or a two-point distance sensor arranged on a side of the device. With the single-point distance sensor, the automatic pool cleaning device is prone to a snake-like movement, resulting in a poor movement along the edges. With the two-point distance sensor, a good movement along edges may be expected for the automatic pool cleaning device in a regular shaped pool, but in an irregular shaped pool, a bad movement along edges may be resulted and the automatic pool cleaning device may suffer scratches by the walls.

Disclosed herein is a control method for an automatic pool cleaning device, wherein the automatic pool cleaning device comprises a laser radar and can clean the pool. For example, the pool is a pond-shaped facility or structure, such as a swimming pool, a water storage pool, a spa pool, a water storage pot, and a water storage tank. The automatic pool cleaning device may be a device capable of cleaning the pond-shaped facility or structure, such as an automatic cleaning device and a pool cleaning robot. This disclosure is not limited to any specific types or presentations of the automatic pool cleaning device and the pond-shaped facility or structure.

When moving along the walls of the pool, the automatic pool cleaning device may obtain contour information on the walls located to a side of the automatic pool cleaning device with the laser radar, and may further determine a yaw angle based on the contour information and then control the automatic pool cleaning device to move along the walls based on the yaw angle. The contour information can characterize accurately the walls of the pool and shapes of objects on the walls, based on which the automatic pool cleaning device may be controlled to move along edges accurately and well.

Hereinafter, unless otherwise specified, a robot will be taken as an example of the automatic pool cleaning device, and the swimming pool will be taken as an example of the pond-shaped facility or structure. Hereinafter, unless otherwise specified, terms "pool bottom", "bottom surface of pool" and "bottom of pool" may all refer to a bottom surface of the swimming pool.

A control method 100 for the automatic pool cleaning device will be described in detail below in connection with the drawings.

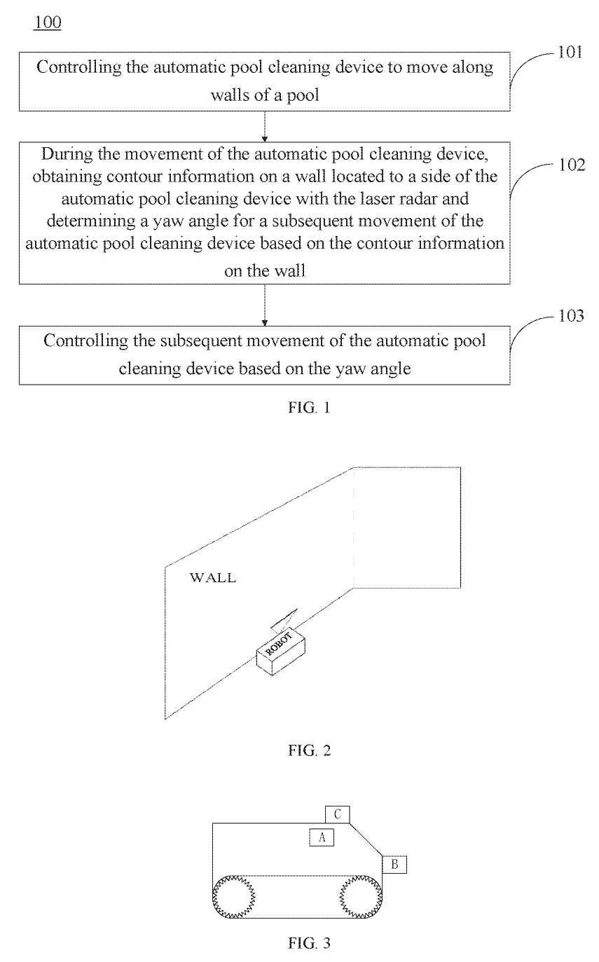

FIG. 1 is a flowchart of the control method for the automatic pool cleaning device in an aspect. As shown in FIG. 1, the control method 100 includes steps 101 to 103, which are described in detail below.

The step 101 is performed firstly. In the step 101, the automatic pool cleaning device is controlled to move along the walls of the pool.

For example, the robot may be configured to clean a pool in a plurality of cleaning modes for example including a pool bottom cleaning mode, a wall cleaning mode and a water surface cleaning mode, where the pool bottom cleaning mode may include a cleaning mode along edges on the pool bottom, and the water surface cleaning mode may include a cleaning mode along edges on the water surface. Cleaning along edges means controlling the robot to move a round along the walls of the swimming pool for cleaning and/or obtaining boundary information of the swimming pool. Cleaning along edges on the pool bottom means controlling the robot to move along the walls of the pool on the pool bottom. Cleaning along edges on the water surface means controlling the robot to move along the walls of the pool on the water surface.

Next, the step 102 is performed. In the step 102, during the movement of the automatic pool cleaning device, contour information on a wall located to a side of the automatic pool cleaning device is obtained with the laser radar, and a yaw angle for a subsequent movement of the automatic pool cleaning device is determined or planned based on the contour information on the wall.

For example, while controlling the robot to move along the wall, a distance between the robot and the wall is controlled. By cleaning along edges with an appropriate distance, for example, accurate pool boundary information may be obtained during the cleaning along edges, so that a better control may be achieved for the pool boundary cleaning and collisions between the robot and the pool wall may be reduced. Thus, while controlling the movement of the robot, the contour information on the wall may be obtained with the laser radar, and the yaw angle for the subsequent movement of the robot along the edges may be determined or planned based on the contour information on the wall, where the yaw angle may characterize an angle at which the robot rotates to the left or right on a horizontal plane.

The laser radar may have a wide scanning range. For example, the laser radar may have a horizontal field of view greater than 100 degrees and a vertical field of view greater than 25 degrees, so that an angle range detectable by the laser radar in a horizontal direction may be greater than 100 degrees, and an angle range detectable by the laser radar in a vertical direction may be greater than 25 degrees. Thus, compared with a simple distance measurement by traditional ultrasonic sensors, contour information on the walls of the swimming pool may be obtained by the laser radar, and sufficient information on the walls may still be obtained even when the automatic pool cleaning device is quite close to the walls. Then, a distance between the automatic pool cleaning device and the walls may be significantly shortened, so that the robot may move along the walls as close as possible, thereby facilitating the robot to obtain more accurate information on the boundary of the pool and also facilitating the cleaning along edges.

In the step 102, the contour information includes two-dimensional contour information or three-dimensional contour information.

For example, the laser radar may be a single-line laser radar or a multi-line laser radar. A single-line laser radar is a laser radar system including only one pair of laser transmitter and receiver. One laser transmitter may emit dozens to hundreds of laser points which are connected into a line so that the laser beam emitted by the one laser transmitter is of a single-line. The distance between the robot and the wall may be calculated by emitting pulses by the single-line laser radar and measuring its return time. Two-dimensional contour information on a wall located to a side of the robot may be obtained based on information on distances of respective points emitted by the laser radar. A multi-line laser radar may have multiple pairs of laser transmitters and receivers built in its sensor, where each pair of the transmitter and receiver may operate independently. The multi-line laser radar may support different specifications such as 4-line, 8-line, 16-line, 32-line, 64-line and 128-line. Each pair of transmitter and receiver of The multi-line laser radar may independently transmit laser pulses and receive return signals. Three-dimensional contour information on the wall located to a side of the robot may be obtained by the multi-line laser radar capable of performing multi-line scanning at the same time. For example depending on actual demands and cost requirements, the laser radar may be either a single-line laser radar or a multi-line laser radar, which is not limited herein.

In the step 102, the contour information on the wall may include information on a contour of the wall itself, and/or may include information on a contour of an object near and independent of the wall.

For example, during controlling the movement of the robot along the wall, the contour information on the wall obtained by the laser radar may only include the contour information on the wall itself when there are no other objects on or near the wall, and the contour information on the wall obtained by the laser radar may include information on contours of the objects when there are other objects (such as ladders) near and independent of the wall. For example, in a case where there are other objects (such as wall lamps) on the wall, the contour information on the wall obtained by the laser radar includes information on a contour of a combination of the wall and the objects.

In the step 102, the contour information on the wall may include information on a contour of a first part of the wall facing a side surface of the automatic pool cleaning device and information on a contour of a second part of the wall obliquely or sideways in front of the automatic pool cleaning device.

For example, as shown in FIG. 2, the contour information on the wall may include information on the contour of a part of the wall facing a side surface of the robot and information on the contour of a part the wall obliquely or sideways in front of the robot, and a scanning range of the laser radar may cover areas located to both a side and a front side of the robot. The area obliquely or sideways in front of the robot will be the area facing a side surface of the robot where the robot will arrive in the future. Based on the contour of the part of the wall obliquely or sideways in front of the robot, the future yaw angle of the robot may be predicted or planned for controlling the robot to make reasonable steering in the subsequently movement so that the robot may be enabled to move along edges accurately. That is, a current yaw angle of the robot is a planned yaw angle which had been planned for the future movement of the robot when the robot was at historical positions at historical moments. By obtaining the contour of the part of the wall currently facing the side of the robot, the current yaw angle of the robot, which had been planned in history, may be further corrected, so that the robot may be further ensured to move along edges accurately. When correcting the current yaw angle of the robot, the correction may be made based on the current yaw angle of the robot, or a new yaw angle may be directly generated. Depending on the contour information on the part of the wall obliquely or sideways in front of the robot, suitable manner of correction may be adopted. For example, when it is determined that the robot is about to collide with the wall or an obstacle based on the contour information on the part of the wall obliquely or sideways in front of the robot, there would be a great collision risk if the robot moved at the current yaw angle. Further, it may be difficult to avoid the collision only by adjusting the current yaw angle of the robot. Then, to enable the robot to avoid the obstacle in time, a new yaw angle may be generated for the robot, to control the robot to move at the new yaw angle and then quickly avoid the wall or obstacle.

For example, the contour of the part of the wall obliquely or sideways in front of the robot may also be obtained only by the laser radar, and a distance to the part of the wall facing a side surface of the robot may be monitored with an ultrasonic ranging sensor.

In step 102, the yaw angle enables the cleaning device to move parallel to the contour of the wall or parallel to the contour of the object.

For example, when controlling the robot to clean along edges, it is expected to control the robot to move along the wall as much as possible without collision. The yaw angle planned or determined based on the contour information on the wall is required to enable the robot to move parallel to the contour of the wall or parallel to the contour of an object near the wall.

In the step 102, the yaw angle for the subsequent movement may include a plurality of yaw angle values for moving to a plurality of positions.

For example, a plurality of yaw angle values at a plurality of positions for the subsequent movement may be planned or determined according to the contour information on the wall, and the number of the plurality of yaw angle values or the plurality of positions may depend on the scanning range of the laser radar and directions of the light beams emitted by the laser radar. For example, multiple yaw angle values at multiple positions in the subsequent movement of the robot may be planned or determined in advance in a case where the laser radar supports to obtain contour information on a part of the wall in a large area obliquely or sideways in front of the robot, and fewer yaw angle values at fewer positions in the subsequent movement of the robot may be planned or determined in advance in a case where the laser radar only supports to obtain contour information on a part of the wall in a small area obliquely or sideways in front of the robot.

In the step 102, the contour information on the wall comprises information on a contour of a part of the wall obliquely or sideways in front of the automatic pool cleaning device, and the yaw angle for the subsequent movement comprises a plurality of yaw angle values at a plurality of different positions.

A part of the wall obliquely or sideways in front of the robot may be sensed when the laser radar senses the wall located to the side of the robot, and multiple yaw angle values at multiple different positions may be planned or determined for the robot in advance based on the sensed part of the wall obliquely or sideways in front of the robot.

Next, a step 103 is performed. In the step 103, the automatic pool cleaning device is controlled to continue to move based on the yaw angle.

For example, after having obtained the contour information on the wall located to the side of the robot by the laser radar and having planned or determined the yaw angle based on the contour information, the robot may be controlled to continue to move based on the planned yaw angle. With the yaw angle planned based on the contour information on the wall located to the side of the robot, the robot may be controlled to move along edges better when controlling the robot to continue to move based on the yaw angle, and collisions between the robot and the wall or objects near the wall may be reduced.

In the step 103, the controlling the automatic pool cleaning device to continue to move based on the yaw angle includes: determining whether a distance between the automatic pool cleaning device and the wall satisfies a preset condition; and updating the yaw angle for the subsequent movement of the automatic pool cleaning device in a case where the distance satisfies the preset condition.

For example, during controlling the robot to move based on the yaw angle, a distance between the robot and the wall may be monitored in real time to determine whether the distance between the robot and the wall satisfies a preset condition. The preset condition may be set in advance, and may be a condition related to an unreasonable distance between the robot and the wall during the movement of the robot along edges. When the distance between the robot and the wall satisfies the preset condition, the yaw angle of the robot is required to be updated to keep a reasonable distance between the wall and the robot during the subsequent movement.

For example, the preset condition includes that the distance between the automatic pool cleaning device and the wall is less than a minimum preset threshold, or is greater a the maximum preset threshold.

For example, there would be a risk of rubbing between the robot and the wall when the distance between the robot and the wall is less than the minimum preset threshold. On the other hand, it would be difficult for the robot to move accurately along edges, there would be large errors in the obtained boundary information on the pool, and it would be difficult to clean the areas near the wall, when the distance between the robot and the wall is greater than the maximum preset threshold. Thus, the yaw angle of the robt may be updated when the distance between the robot and the wall is less than the minimum preset threshold or greater than the maximum preset threshold.

For example, the laser radar may be installed at a side part or head part of the automatic pool cleaning device.

For example, the laser radar may be installed on the side part or head part of the automatic pool cleaning device. FIG. 3 is a schematic diagram of the installation position of the laser radar in an example. As shown in FIG. 3, for example, the laser radar may be arranged at the side part of the robot and near the head part of the robot, like the laser radar A in FIG. 3, and may also be arranged at the head part of the robot and near the side part of the robot, like the laser radar B in FIG. 3, and may also be arranged on the top of the robot, like the laser radar C in FIG. 3, where the laser radar may be configured to emit light beams obliquely downward to collect the contour information on a part of the wall located to the side of the robot and/or a part of the wall obliquely or sideways in front of the robot. Three example installation positions have been illustrated in FIG. 3, but it does not mean that three laser radars is required or expected to be configured for the robot. Only one laser radar or two laser radars may be equipped on the robot as needed. The laser radar may be selectively configured according to actual needs, for example, the number and positions of the laser radar may be configured selectively.

The above described installation positions of the laser radars are only exemplary, and the installation positions of the laser radars are not limited to the above examples. The positions of respective radars may be configured or planned according to the actual situations.

For example, a light beam emit by the laser radar may be parallel to or intersect with the horizontal plane.

For example, contour information on a part of the wall located to a side of the robot at the same height as the laser radar may be obtained with the laser radar when the light beam emitted by the laser radar is parallel to the horizontal plane. When the light beam emitted by the laser radar intersects with the horizontal plane, contour information on a part of the wall near the bottom of the swimming pool and located to a side of the robot may be obtained by the laser radar, and the obstacles at the bottom of the swimming pool next to the wall may be further scanned.

In the control method for the automatic pool cleaning device, during the movement of the automatic pool cleaning device along walls of the pool, the contour information on a wall located to a side of the automatic pool cleaning device may be obtained with the laser radar, the yaw angle may be further planned or determined based on the contour information, and the automatic pool cleaning device may be controlled to move along the wall based on the yaw angle, wherein the contour information can accurately reflect shapes of both the wall of the pool and the objects on the wall. The automatic pool cleaning device can be controlled to move along edges accurately based on the contour information, so that a good movement along edges may be achieved.

In a second aspect, also disclosed an automatic pool cleaning device. The automatic pool cleaning device includes a laser radar a laser radar, and a processor configured to performing the control method in the above respective examples by executing a program in a storage. The description of the control method in the above respective examples executed by the automatic pool cleaning device is omitted here, the details of which have been described above in connection with various examples and drawings and thus are not repeated here.

In a third aspect, also disclosed a non-transient computer-readable storage medium having a computer program stored, and the control method for the automatic pool cleaning device, which has been described in the above examples, may be performed when the computer program is executed by a processor, wherein the automatic pool cleaning device comprises a laser radar, and the method comprises: controlling the automatic pool cleaning device to move along walls of a pool; during the movement of the automatic pool cleaning device, obtaining contour information on a wall located to a side of the automatic pool cleaning device with the laser radar and determining a yaw angle for a subsequent movement of the automatic pool cleaning device based on the contour information on the wall; and controlling the subsequent movement of the automatic pool cleaning device based on the yaw angle. The description of the control method in the above respective examples executed by the automatic pool cleaning device is omitted here, the details of which have been described above in connection with various examples and drawings.

In a fourth aspect, also disclosed is a computer program product comprising a computer program. The computer program may be stored on a non-transient computer-readable storage medium, and the control method for the automatic pool cleaning device, which has been described in the above examples, may be performed when the computer program is executed by a processor, wherein the automatic pool cleaning device comprises a laser radar, and the method comprises: controlling the automatic pool cleaning device to move along walls of a pool; during the movement of the automatic pool cleaning device, obtaining contour information on a wall located to a side of the automatic pool cleaning device with the laser radar and determining a yaw angle for a subsequent movement of the automatic pool cleaning device based on the contour information on the wall; and controlling the subsequent movement of the automatic pool cleaning device based on the yaw angle. The description of the control method in the above respective examples executed by the automatic pool cleaning device is omitted here, the details of which have been described above in connection with various examples and drawings.

The examples of the device described above are only schematic, in which units (or modules, or circuits) described as separate components may or may not be physically separated. Components shown as units may or may not be physical units, that is, they may be located in one place or distributed to multiple network units. Some or all of the modules can be selected according to actual needs, which may be understood and implemented by those skilled in the art without creative labor.

Based on the descriptions of the above examples, one or more aspects of the above example control method may be implemented with software and necessary general hardware platforms, and or be implemented with hardware. For example, the above example control method may be implemented or embodied in a form of a software product, which can be stored in computer-readable storage media such as ROM/RAM, magnetic disks, optical disks, etc., including several instructions to enable a computer device (for example, a personal computer, server, or network device, etc.) to execute the method or some parts of the method.

In the description of this manual, the reference to the terms "one example", "some examples", "examples", "specific examples", or "several examples" means that the specific features, structures, materials, or characteristics described in conjunction with the embodiment or example are included in at least one embodiment or example of this disclosure. Moreover, the specific features, structures, materials, or characteristics described can be combined in any one or more embodiments or examples in an appropriate manner. In addition, technicians in this field can combine and combine the different embodiments or examples described in this specification, as well as the features of different embodiments or examples, without conflicting with each other.

In addition, the terms "first" and "second" are only used for descriptive purposes and cannot be understood as indicating or implying relative importance or implying the number of technical features indicated. Therefore, the features modified by "first" and "second" can explicitly or implicitly include at least one of these features. In addition, the wording "multiple" refers to two or more, unless otherwise specifically limited.

The scope of protection of the present disclosure is not limited to the above examples. Any changes or replacements, which can be easily thought out by those skilled in the art, also fall into the technical scope of this disclosure, and the scope of protection of this disclosure should be based on the scope of protection of the claims.

What is claimed is:

1. A control method for an automatic pool cleaning device comprising a laser radar, the control method comprising:
controlling the automatic pool cleaning device to move along walls of a pool;
during the movement of the automatic pool cleaning device, obtaining contour information on a wall located to a side of the automatic pool cleaning device with the laser radar and determining a yaw angle for a subsequent movement of the automatic pool cleaning device based on the contour information on the wall; and
controlling the subsequent movement of the automatic pool cleaning device based on the yaw angle.

2. The control method of claim 1, wherein the contour information comprises two-dimensional contour information or three-dimensional contour information.

3. The control method of claim 1, wherein the controlling the subsequent movement of the automatic pool cleaning device based on the yaw angle comprises:
determining whether a distance between the automatic pool cleaning device and the wall satisfies a preset condition; and
updating the yaw angle for the subsequent movement of the automatic pool cleaning device in a case where the distance satisfies the preset condition.

4. The control method of claim 3, wherein the preset condition comprises the distance being less than a minimum preset threshold or the distance being greater than a maximum preset threshold.

5. The control method of claim 1, wherein the contour information on the wall comprises information on a contour of the wall itself or a contour of an object near and independent of the wall.

6. The control method of claim 5, wherein the contour information on the wall comprises information on a contour of a first part of the wall facing a side surface of the automatic pool cleaning device and information on a contour of a second part of the wall obliquely or sideways in front of the automatic pool cleaning device.

7. The control method of claim 5, wherein the yaw angle enables the automatic pool cleaning device to move parallel to a contour of the wall or parallel to a contour of the object.

8. The control method of claim 1, wherein the yaw angle for the subsequent movement comprises a plurality of yaw angle values for moving to a plurality of positions.

9. The control method of claim 1, wherein the laser radar is installed at a side part or head part of the automatic pool cleaning device.

10. The control method of claim 1, wherein a light beam emitted by the laser radar is parallel to or intersects with a horizontal plane.

11. The control method of claim 1, wherein the contour information on the wall comprises information on a contour of a part of the wall obliquely or sideways in front of the automatic pool cleaning device, and the yaw angle for the subsequent movement comprises a plurality of yaw angle values at a plurality of different positions.

12. An automatic pool cleaning device, comprising:
a laser radar; and
a processor configured to perform controlling the automatic pool cleaning device to move along walls of a pool; during the movement of the automatic pool cleaning device, obtaining contour information on a wall located to a side of the automatic pool cleaning device with the laser radar and determining a yaw angle for a subsequent movement of the automatic pool cleaning device based on the contour information on the wall; and controlling the subsequent movement of the automatic pool cleaning device based on the yaw angle.

13. The automatic pool cleaning device of claim 12, wherein the contour information comprises two-dimensional contour information or three-dimensional contour information.

14. The automatic pool cleaning device of claim 12, wherein the controlling the subsequent movement of the automatic pool cleaning device based on the yaw angle comprises:
determining whether a distance between the automatic pool cleaning device and the wall satisfies a preset condition; and
updating the yaw angle for the subsequent movement of the automatic pool cleaning device in a case where the distance satisfies the preset condition.

15. The automatic pool cleaning device of claim 14, wherein the preset condition comprises the distance being less than a minimum preset threshold or the distance being greater than a maximum preset threshold.

16. The automatic pool cleaning device of claim 12, wherein the contour information on the wall comprises information on a contour of the wall itself or a contour of an object near and independent of the wall.

17. The automatic pool cleaning device of claim 16, wherein the contour information on the wall comprises information on a contour of a first part of the wall facing a side surface of the automatic pool cleaning device and information on a contour of a second part of the wall obliquely or sideways in front of the automatic pool cleaning device.

18. The automatic pool cleaning device of claim 16, wherein the yaw angle enables the automatic pool cleaning device to move parallel to a contour of the wall or parallel to a contour of the object.

19. The automatic pool cleaning device of claim 12, wherein the yaw angle for the subsequent movement comprises a plurality of yaw angle values for moving to a plurality of positions.

20. The automatic pool cleaning device of claim 12, wherein the laser radar is installed at a side part or head part of the automatic pool cleaning device.
